(19) United States
(12) Patent Application Publication
(10) Pub. No.: US 2008/0189212 A1
(43) Pub. Date: Aug. 7, 2008

(54) Electronic secure authentication for exchange buyer assurance system (eSafeBay)

(76) Inventors: Michael Kulakowski, (US); Robert Kulakowski, (US)

Correspondence Address: Michael Kulakowski, 5 Carlson Court, Jackson, NJ, 08527, US

(21) Appl. No.: 12/002,811

(22) Filed: Dec. 19, 2007

Related U.S. Application Data
(60) Provisional application No. 60/876,308, filed on Dec. 21, 2006.

(51) Int. Cl. G06Q 30/00; H04L 9/00

(52) U.S. Cl. 705/50

(57) ABSTRACT

The electronic Secure Authentication For Exchange Buyer Assurance System (eSafeBay) establishes an integrated secure computerized network to ensure that products or items offered for auction and/or purchase from an internet auction site, electronic commerce site, or similar electronic auction business entity (referred to collectively as an “auction”) are authenticated prior to the product's purchase against counterfeiting or piracy by enacting an RFID “Cryptographic Authentication Challenge” as detailed within the “Security authentication system for collectible and consumer items” (U.S. patent application Ser. No. 11/157,282), or other secure authentication method.

The present application claims the benefit of the “electronic Secure Authentication For Exchange Buyer Assurance System (eSafeBay)” U.S. provisional patent application No. 60/876,308 filed Dec. 21, 2006 which is incorporated herein by reference in its entirety.

### BACKGROUND OF THE INVENTION

Over the last few years, customers acquiring products while participating in electronic auctions or on electronic commerce sites often end up with products that are inferior to those that they had bid on or purchased with such products often being counterfeited from unauthorized manufacturers, pirated from unauthorized distributors or retailers, illegal, or the products that the customer subsequently receives is not the original product the customer believed they had won at auction or purchased. Customers so “cheated” by dubious vendors often have no recourse but to absorb their “loss” and to be more diligent while participating in future auctions or purchase endeavors.

### BRIEF SUMMARY OF THE INVENTION

The intent of the eSafeBay System is to facilitate validated, authentic and secure product exchange between participating members of the eSafeBay System to detect and eliminate the potential that a product is counterfeited, pirated, stolen, damaged, recalled, swapped, and/or unlawful, etc. In situations where a given product is electronically evaluated and determined to be counterfeited, pirated, stolen, damaged, recalled, previously owned when being auctioned as new or sold as new, or unlawful, etc., users of the eSafeBay System are notified immediately of that circumstance and advised accordingly. In situations where a product is determined to be unlawful or dangerous due to a previously damaged condition, recall, etc. the proper law enforcement or governing authority may be notified. The overall goal of the eSafeBay System is to guarantee that auction bidders/winners and buyers of eSafeBay products are guaranteed that the products offered for auction or sale are authentic products and that customers are completely assured of the authenticity and lawfulness of the products being offered for auction or sale.

### BRIEF DESCRIPTION OF THE DRAWINGS

FIG. 1—Authenticate & Purchase ‘Button’ initiated process accessible from an ecommerce web page that commences the product's authentication process. A similar Authentication& Bid ‘Button’ initiated process would be used within an electronic auction web page, but is not shown from a web-based auction.

FIG. 2—Authentication Result, Purchase Recommendation, Authentication Details, Purchase button, View Incentives button & View Services button that the customer uses to purchase the product and view or include Incentives and Services corresponding to the authenticated product.

FIG. 3—Cellular Telephone Authentication Process Button used to authenticate products from a mobile device's electronic auction site that additionally displays auction bids placed on the subject product.

FIG. 4—Authentication Result, Purchase Recommendation, View Incentives button, View Services button, and Purchase link that is displayed on a cellular telephone's access of an electronic auction site.

FIG. 5—Authentication Results & Place Bid process that details the authentication results and provides the ability to place bids on the authenticated product on a cellular telephone's access of an electronic auction site.

FIG. 6—Product Reservation Enactment process to reserve authenticated products for later purchase or to reserve a place within an auction for bidding on authenticated products on a cellular telephone's access of an electronic ecommerce or electronic auction site.

FIG. 7—Cellular Telephone Direct Incentive Authentication Link Incentives offer details that are presented to customers for authenticated products.

FIG. 8—Cellular Telephone Direct Incentive Authentication Link Services offer details that are presented to customers for authenticated products.

### DETAILED DESCRIPTION OF THE INVENTION

In this application, a reference to a cellular telephone should be considered a reference to either, but not limited to: an RFID Reader, PDA, PC, Laptop, electronic Notebook, Scanner, or any other form of electronic Trusted RFID reading device that can be accessible, communicated with, authenticated and capable of reading or interacting with any form of RFID Tag, Bar Code, Hash, Encrypted Serial Number, Electronic Product Code, Product Markup Language, and/or future product identification process.

In a preferred embodiment, an eSafeBay customer/user establishes a secure electronic connection to the eSafeBay computer network using an eSafeBay networked capable cellular telephone (or an Interrogator, RFID Reader, PDA, PC, Laptop, or any other form of electronic (RFID reading or Secure ID reading) device) that employs the connectivity security, product authentication and data access restrictions contained within the “Secure RFID authentication system” and “Secure RFID Authentication System using non-trusted communications agents” (U.S. patent application Ser. No. 11/268,162, filed by Michael Kulakowski and Robert Kulakowski), or other secure authentication method, and/or other secure communication systems and methods.

Various functional aspects and data elements of the eSafeBay System control access to system's vital processes. eSafeBay System's Safeguards are established to impose restrictive access to both digital hardware components and data resources that safeguard members and their possessions within and outside the eSafeBay System Network.

For definitive purposes within this Application, a distinction between an eSafeBay System “compliant product” and “non-compliant” product centers upon the actual (RFID or digital identifying) tagging of a product. eSafeBay compliant products are those products that have received RFID tags issued in accordance with the “Security authentication system for collectible and consumer items” (U.S. patent application Ser. No. 11/157,282), or other secure authentication method, whereby a manufacturer or Authentication Authority Agent has attached or embedded a compliant RFID tag to a product. The creation of secure digital records detailing the identity of the product's model, serial number, manufacturer, etc., its tagging—location & device, the corresponding RFID reader's and computer system's identity, the responsible issuing Trust Authority Agency, the results of the product's subsequent authentication challenges, and/or an x-ray image capturing the telemetric position and orientation of RFID tag positioning attached to/or embedded within a product, may wholly or in part, contribute toward a product being designated as an eSafeBay “compliant product” eligible to participate within an eSafeBay Auction or Sales offering.

Non-Compliant Product eSafeBay Appraisal:

For products that do not have an eSafeBay compliant RFID tag attached to/or embedded within (an eSafeBay ‘non-compliant product’) the product, an affiliated/authorized eSafeBay Appraisal service representative may conduct an physical appraisal of a product prior to its auctioning or sale within the eSafeBay Network. Upon the appraisal's determination that the non-compliant product's authenticity against counterfeiting, pirating, stolen, damaged, recalled, swapped, unlawfulness, etc., has been successfully matched, an eSafeBay compliant RFID tag may be attached to/or embedded within the product, thereby making the ‘non-compliant product’ an eSafeBay ‘compliant product’. The eSafeBay compliant RFID tag is permanently attached or embedded within the product using advanced adhesive material(s) that permanently adhere the RFID tag to the product in such manner that should an eSafeBay compliant RFID tag be “forcefully” removed from a compliant product, the previously adhered RFID tag is rendered electronically inoperable from future RFID reader interrogation, and visually and evidentially tampered with, resulting from the force, prying, cutting, heating, etc. necessary to remove the compliant RFID tag from the eSafeBay compliant product.

For extremely valuable products, an x-ray image capturing the telemetric position and orientation of compliant RFID tag positioning enhances the authentication strength of the eSafeBay compliant product within the eSafeBay network.

Products undergoing an eSafeBay Appraisal “examination and tagging” process are photographed, evaluated using contemporary valuation methodologies to determine value and/or market value, and subsequently entered into the eSafeBay System network.

At such time, users or owners of newly authenticated products converted to an eSafeBay compliant product may elect to implement one or several of the “Enhanced Additional Services” (see below) upon their eSafeBay compliant product.

### Non-Compliant Product Auction or Sales

Entry of a non-compliant product into an eSafeBay System auction or sales offering is so identified and presented to auction participants or shoppers as “non-compliant”, potentially “un-trustworthy”, or “un-authenticable” with a majority of previously referenced authentication and security safeguards missing for the a non-compliant product.

### Restrictive Access

Further examples of restrictive access includes, but are not limited to: RFID Tags undergoing an Authentication Challenge are governed by a Trust Authority Agency/Authentication Authority Agent acting as a member of the eSafeBay System. Products possessing a manufacturer attached or installed Cryptographic RFID tag are processed by the Authentication Authority Agent once the proper identification, authentication, and access level of the digital RFID reader device meets the appropriate parameters.

When the eSafeBay System or its Authentication Authority Agent detects a digital RFID reader device that is not an authorized or affiliated device of the eSafeBay System, the results of an authentication challenge may not be provided to the reader and limited or no data is exchanged with the “rogue” RFID reader. Each Authentication Challenge on an eSafeBay System's member product may include “Report back technology” that alerts members when one of their products have been read by a non-familiar RFID reader.

Associated Data Exchange Restrictions impose safeguard on the breath of data that the Trust Authority and or the eSafeBay System can convey to a RFID reader. For instance, an eSafeBay System member establishes restrictions on their product(s) offered for auction or sale at a trade show whereas the results of an Authentication Challenge are available to other individuals (not members of the eSafeBay System) reading an RFID tag, but wish to restrict ownership, purchase, and appraisal data. Secondly, an eSafeBay System member may anonymously present product data to a “Sales Broker” to establish demand for that product, but wish to prevent any data other than the product's description, image, and historical information from being transferred to any perspective purchasers.

eSafeBay system affiliated readers & associated electronic device restrictions include, but are not limited to: readers are authenticated by the Trust Authority Agency to perform reads on affiliated RFID tags. Additionally, restrictions may be imposed on electronic devices such as cash registers, cellular telephones, etc. to enact transactions on a specific product type, monetary amount, or particular retail environment. An example of an eSafeBay System transaction restriction centers upon the eSafeBay System's blocking of electronic transactions by a college student using a cellular telephone to purchase alcohol at a liquor store (a restriction established by the student's parents). Within an auction environment, a transaction restriction may be imposed upon dubious auctioneers that consistently “cheat” their customers.

For consistency purposes within this application, the submittal of products for either auctioning or purchasing, or the placement of a winning bid dollar amount or the purchasing of a product is considered as a financial transaction.

Additionally, an eSafeBay System user may impose restrictions on the maximum dollar amount expendable for a financial transaction to be completed at a given location, date or time, credit amount or for a given product. Furthermore, an authentication threshold may be established whereby any transactions over a specific dollar amount transacted by an eSafeBay System cellular telephone or electronic device requires additional authentication comparing biological information—such as a user's voice print, eye iris ring, facial structure, or finger print, etc. to the acknowledged corresponding voice print, eye iris ring, facial structure, or finger print being stored within the affiliated Trust Authority Agency data banks. In instances where the user's biological challenge fails, the cellular telephone or electronic devices registered and belonging to the “compromised” user, that actually may have been stolen or wrongfully used to enact transactions, may be temporarily suspended from conducting future RFID reads or performing future, transactions until the user and their devices can be re-authenticated to the eSafeBay System with it's stored biological data.

An eSafeBay auction user desiring to create an auction or offer for sale a product in their possession conducts the following tasks:

| | |
|---|---|
| Log In | Log in to the eSafeBay session. Upon |
| | successful log in, an authenticated secure |
| | eSafeBay session is created |
| Service | User determines whether an item should be |
| Selection | offered as either an eSafeBay “Immediate |
| | Sale” or “Auction” product |
| Image | When applicable, an eSafeBay digital |
| Creation | camera equipped cellular phone can |
| | photograph the item to be sold or |
| | auctioned |
| RFID tag scan | An eSafeBay cellular phone equipped with |
| | an RFID reader interrogates the item's |
| | RFID tag |
| Authentication | The item to be soid or auctioned is |
| | authenticated under the auspices of |
| | “Security authentication system for |
| | collectible and consumer items” (US patent |
| | application #: 11/157,282) to: |
| | Identify counterfeit products |
| | Identify damaged, expired or recalled |
| | products |
| | Evaluate ownership chain to products |
| | Determine “grey market” products |
| | Provides digital authenticated appraisals |
| | or assessments for valuable and |
| | collectable products |
| | Expose stolen products |
| | Determine “swapped” products |
| Payment | Conduct various financial transaction |
| Services | settlement procedures between auctioneer/ |
| | seller and auction winner/purchaser |

### Authentication Challenge Results

The Authentication Challenge is conducted in “real-time” by a Trust Authority (TA)/Authentication Authority Agent from within the eSafeBay Server Network.

The Trust Authority (TA)/Authentication Authority Agent is also responsible for securing and authenticating any participating entity as well as all associated digital electronic devices within the eSafeBay Server Network's Auction system.

The Trust Authority/Authentication Authority Agent ensure that the established security, accessibility, and authenticity requirements imposed upon the following:
Customers
Manufactures
Distributors
Retailers
Credit Card Company
RFID Readers
Communication Devices
Networks
Computer Systems
Communication Links
Internal and External Data
Internal and External Messages
Internal and External Incentive Offer messages
are met and that all aspects of the eSafeBay application are “cryptographically authentic”, or authenticated by another secure authentication method, recorded, verifiable, repeatable, and guaranteed. Efforts are made to insure that the eSafeBay affiliated companies and users are in “good standings” within the network and that the integrity of their products, services, offerings, etc. contributes toward the goals and authenticity of the eSafeBay System Network.

The Authentication Challenge (pass, fail, or unknown) messages are communicated directly to the user's trusted electronic (RFID reading) device (preferably a cellular telephone) by utilizing the following device's:
Display screen,
HTTP web page
Video capacity,
Audio system,
Illumination system,
Buttons & Dials
Vibratory pattern
Text
Tones
Music
Flashing
Buzzing
Timer/Clock

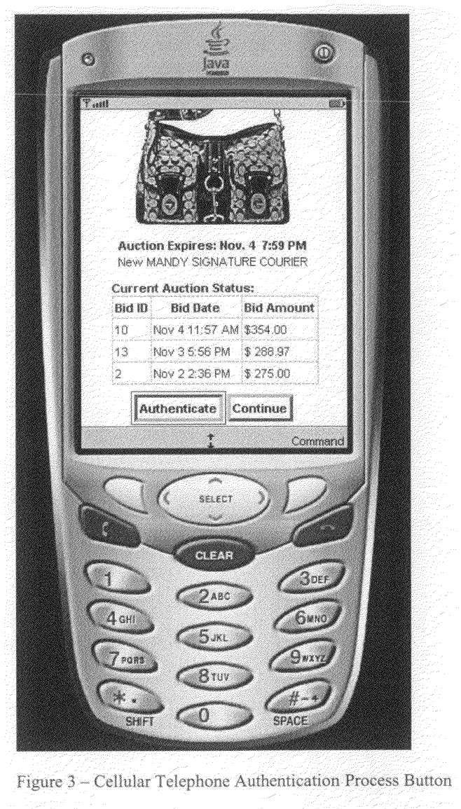

Once a product has successfully passed the Cryptographic Authentication Challenge specified by the “Security authentication system for collectible and consumer items” (U.S. patent application Ser. No. 11/157,282), or other secure authentication method, the product is deemed “valid” and “not counterfeit”, “not pirated” and not “stolen”. The product is then placed into an auction or offered for sale. Upon successful creation of a product's auction or offering for sale within the eSafeBay network, a series of Secure Messages constituting “Successful Auction or Sales Offering & Authentication” are transmitted from the eSafeBay (via the eSafeBay Server Network's Trust Authority (TA)/Authentication Authority Agent) directly to the consumer's “Trusted Device”, such as an authenticated cellular telephone (Illustrations—FIG. 3) (preferable embodiment), or an RFID Reader, PDA, PC, Laptop, or any other form of electronic (RFID reading or Secure ID reading) device that can be authenticated as a “Trusted Device” within the eSafeBay Server Network) in an authenticated, secure fashion meeting the Trusted Devices Authentication and Security protocols (U.S. patent application Ser. No. 11,157,282) and the Secure RFID authentication system and Secure RFID authentication system using non-trusted communication agents patent applications technology (U.S. patent application Ser. No. 11/728,792)

Products that have successfully passed the Authentication Challenge and entered into either an auction and/or offered for sale have their Cryptographic ‘public key’, RFID Electronic Product Codes EPC codes, or associated ID(s) recorded and intrinsically linked to the corresponding auction or sales offering.

Should an item fail the above referenced “Authentication Challenge” that item may be prohibited from being placed into an auction or from being offered for sale and an electronic record of such failure is created.

An “Authentication Remediation Process” allows eSafeBay users to address discrepancies that have disqualified their products from participation within an eSafeBay auction or sales effort. An example of such a disqualification centers upon a “breach in the ownership” chain whereby the eSafeBay acknowledged owner of the product and the individual offering the product for auction or sale are not the same. In this case, to remedy the conflict, the eSafeBay acknowledged owner would simply electronically “permit” the product to be placed into auction or sale and thereby designate the eSafeBay user as the “auction agent” for the said product on behalf of the eSafeBay acknowledged owner.

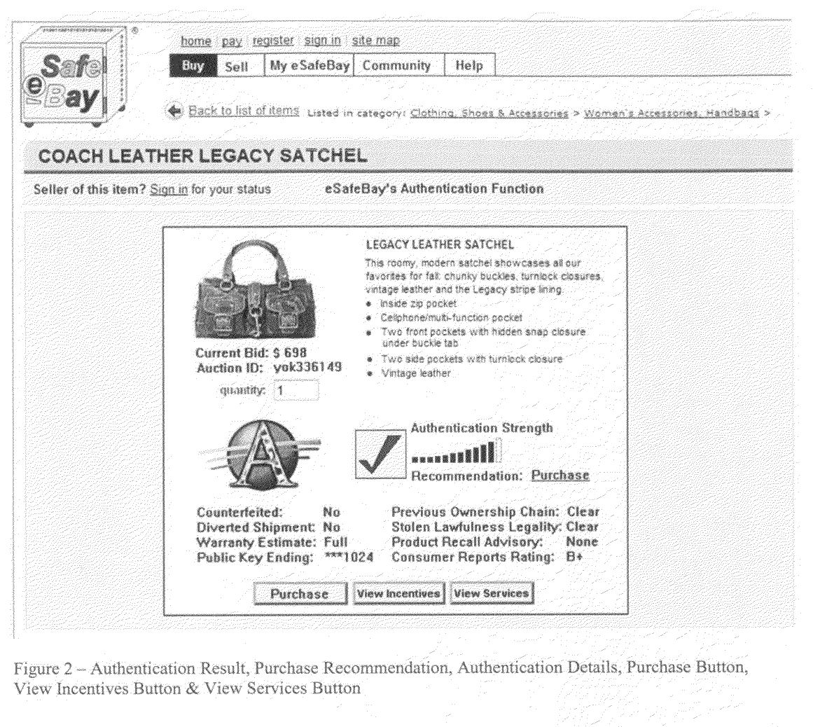

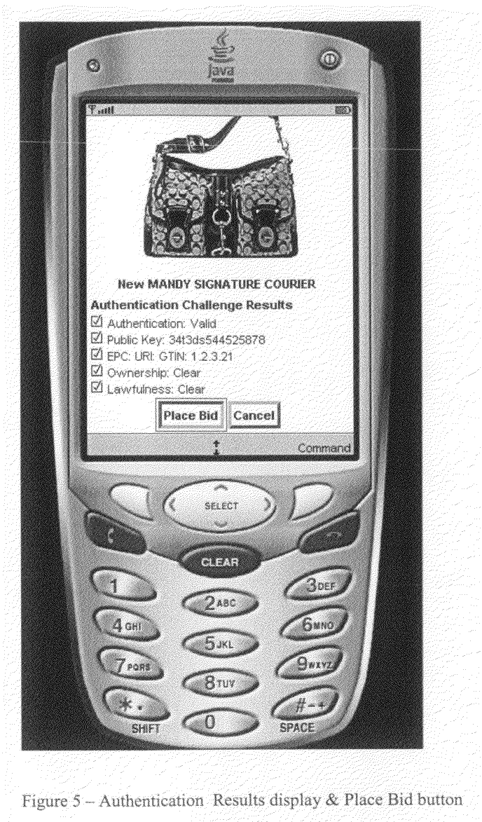

Once a product successfully clears all authentication challenges, the product is then offered for auction (FIG. 5) or sale (FIG. 2) within the eSafeBay system and is accessible to potential buyers through either an eSafeBay internet web site or from the eSafeBay enabled cellular telephone or any conforming digital device.

eSafeBay Shopping is conducted by both eSafeBay members and non-members through either an eSafeBay authenticated and approved website or from an eSafeBay approved electronic auction device consisting of but not limited to: Cellular Telephones, Personal Digital Assistants, Personal Computers, Laptop Computers, digital devices, or similar devices, etc., that are capable of establishing an authenticated electronic connection to the eSafeBay Server Network within the auspices specified within the “Secure RFID authentication system” and “Secure RFID Authentication System using non-trusted communications agents” (US patent applications Kelly).

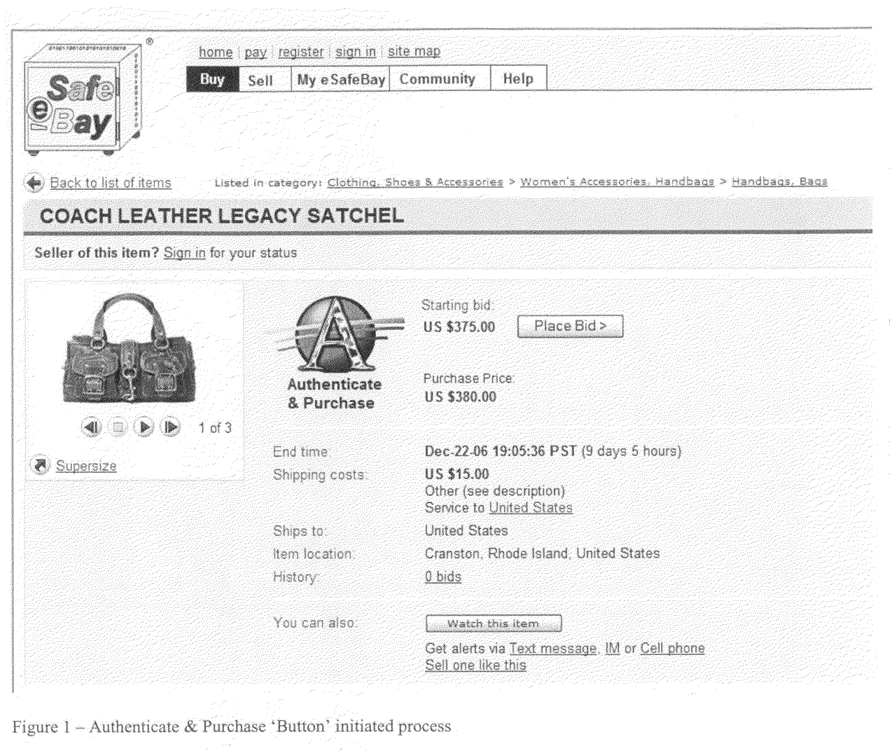

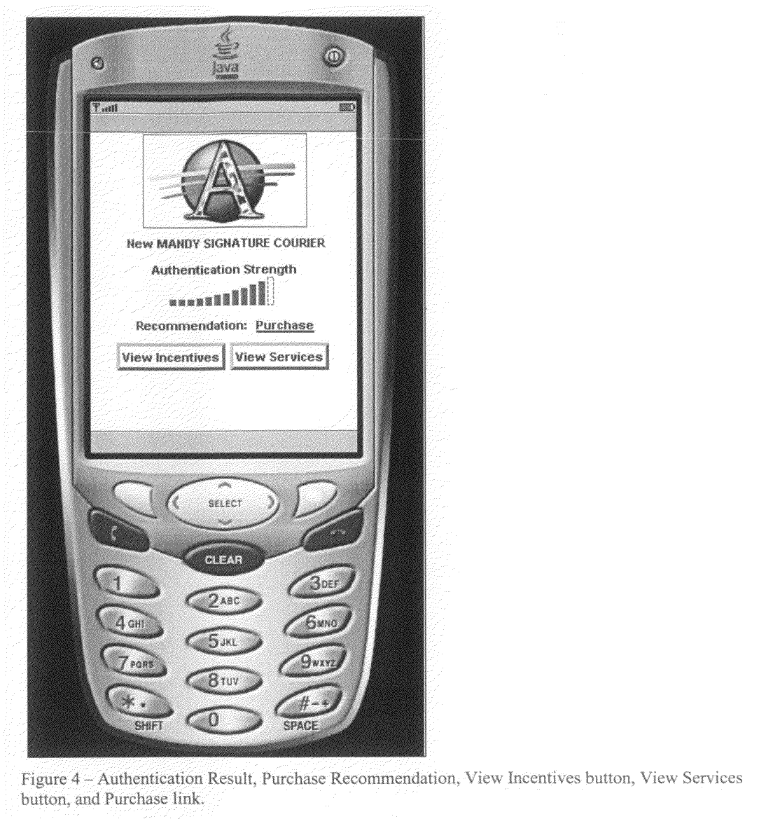

During product searching a customer can perform a real-time Authentication challenge on a product by pressing or clicking an Authentication button accessible from a cellular telephone, web page, or a similar conforming electronic device and reviewing the results (FIG. 1, FIG. 2, FIG. 3, & FIG. 4).

### Auction Participation or Product Purchase Reservations

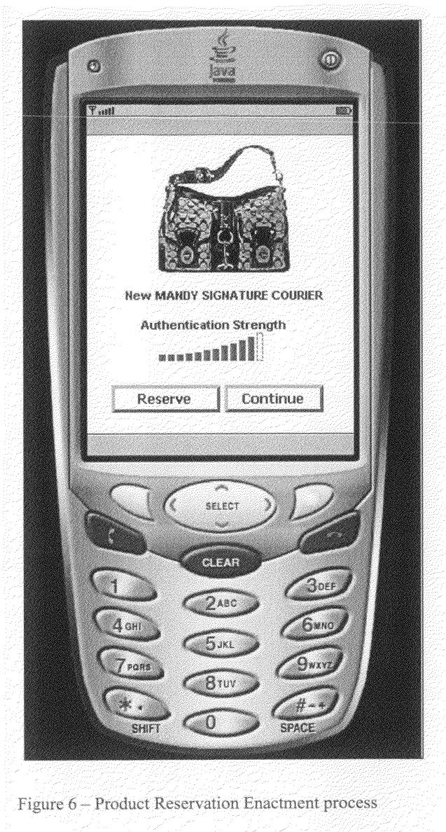

In instances where a sought after product is digitally located as being offered for auction or purchase, an eSafeBuy customer may place a digital (either manual or automatic initiated) “hold & reserve reservation” (FIG. 6) on that product for their exclusive participation within a “new auction” or purchase that product directly and arrange for its subsequent pick-up or delivery. The eSafeBay customer has a predetermined “reservation period” for the located product and must join the auction within a certain period from inception or purchase that product from the given retailer before the reservation lapses. When a reservation lapses, an eSafeBay customer may “renew a reservation” on the product should the product remain available in auction or for purchase without any other “holds” placed upon it. In situations where an eSafeBay offered product is in short supply and is currently reserved by a particular eSafeBay customer, another eSafeBay customer may be placed on a “waiting list” to participate in the auction of purchase should the initial eSafeBay customer's reservation lapse as described above. Should the reservation lapse on a reserved product, the next eSafeBay customer is automatically advised of the current availability of the product and given the opportunity to place their own “hold” on that product or enact an immediate purchase transaction.

Once a potential purchaser completes a purchase or wins an auction for a given product, a Transaction Record is created by the eSafeBay Network System identifying the necessary transaction data, including but not limited to:
Product Name
Product Model
Product Serial #
Product Public Key
Product EPC Code
Reader/Interrogator ID
Authentication Result/ID
Auctioneer's or Seller's ID
Auction or Sales Date
Transaction ID
Transaction Amount
Transaction Currency
Credit Card or Electronic Payment Number
Credit Card Expiration Date
Purchaser's Name
Purchaser's ID
Purchaser's Address ID
Purchaser's Contact ID
Delivery Service ID
Delivery Authentication Result/ID
Delivery Confirmation ID
Transaction Payment Settlement ID

### Auction Winner or Purchase Confirmation

Once the auctioneer/seller and the auction winner or purchaser have consummated the transaction in accordance with the guidelines and rules of the eSafeBay System, a series of digital confirmation notices or certificates are generated, whereas each entity receives the appropriate message or certificate, including but not limited to the following:
An auctioneer/seller confirmation detailing the transaction id, customer details, currency, price, requested shipper and expected shipment date
An auction winner/purchaser confirmation detailing the transaction id, currency, price and expected shipment/reception details
Pre Shipment Authentication Challenge—once a product is presented for shipment with a participating eSafeBay delivery service: an authentication challenge may be conducted to verify the appropriate packaged contents correspond to the product's EPC, ID contained within the Transaction Record. Upon successful authentication of the packaged product, a record of the shipment is automatically associated with the Transaction Record and the appropriate Tracking Details are forwarded to the auction winner or purchaser. In instances whereby the challenge may be “unknown” or “indeterminable”, a record of such condition is included within the Transaction Record. Likewise, the auction winner or purchaser is apprised of the unsuccessful Pre Shipment Authentication Challenge

### Auction Winner or Purchaser Delivery Product Reception

The purchaser or auction winner upon arrival of the auctioned or purchased product can use their eSafeBay Networked Cellular Telephone RFID Reader to read the RFID EPC Code and orchestrate an “Cryptographic Authentication Challenge” as detailed within the “Security authentication system for collectible and consumer items” (U.S. patent application Ser. No. 11/157,282), or other secure authentication method. The Authentication Challenge (pass, fail, or unknown) (FIG. 3, FIG. 4) messages are communicated directly to the purchaser or auction winner trusted electronic (RFID interrogator) device (preferably a cellular telephone) such that the purchaser or auction winner is notified of the outcome (see above) whereby they may refuse to accept the product having an unsuccessful or invalid authentication challenge outcome. For products having a successful or valid authentication challenge, the transaction is automatically closed upon the product's reception, and the Transaction Record is updated accordingly. The auctioneer or seller is advised of the auction winners or purchaser's reception of the product and the transfer of funds are electronically conducted via the eSafeBay System Payment Services or eSafeBay Settlement Service. Also, a product's ownership registration record may be updated with the eSafeBay ID data of the product's new owner.

### Enhanced Additional Services

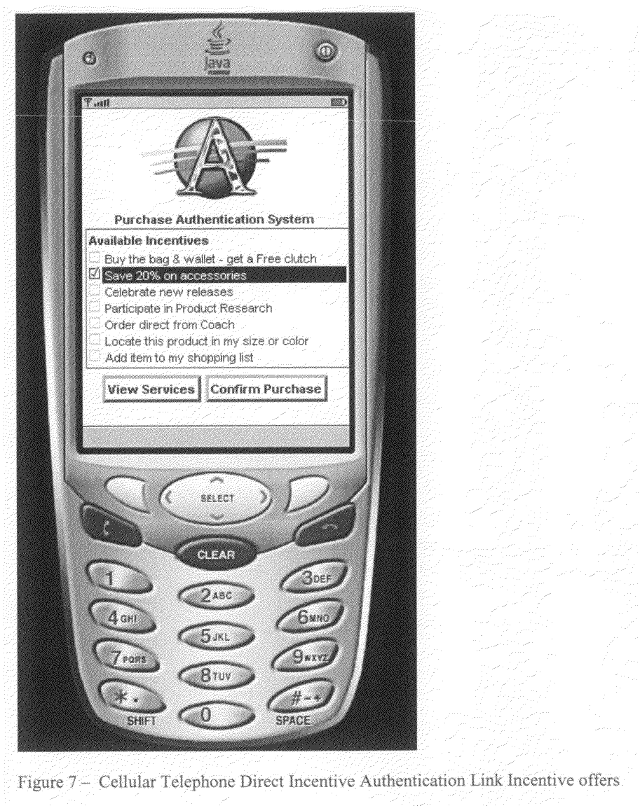

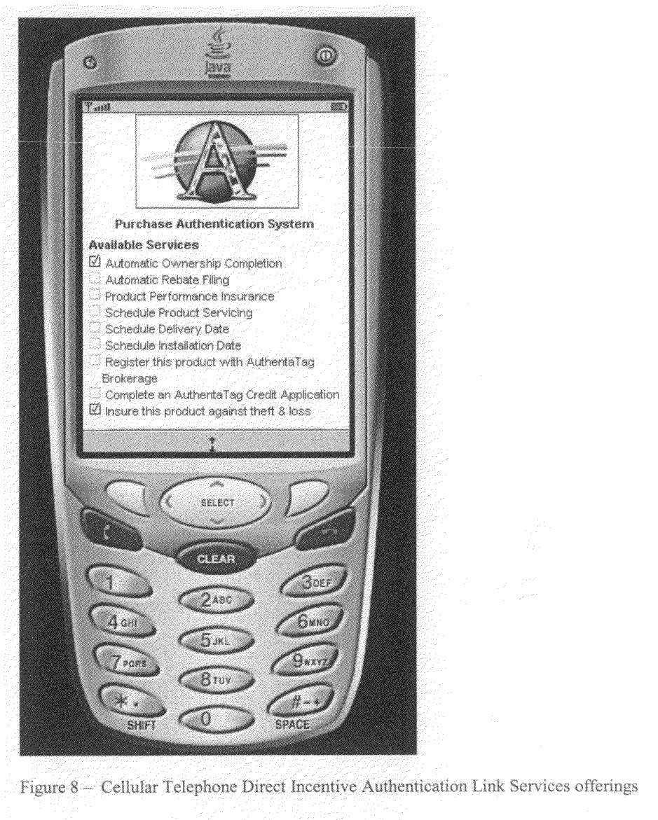

eSafeBay members and non-members may receive enhanced additional incentive and services offerings (FIG. 7, FIG. 8) associated with products obtained from an eSafeBay auction or sales offering as contained within the “Direct Incentive Authentication Link (DIAL) System” (U.S. patent application Ser. No. 11/881,506, filed by Michael Kulakowski and Robert Kulakowski) consisting of, but not limited to:
Electronic Ownership Registration
Electronic Completion and Electronic Filing of Rebates
Product Delivery Scheduling
Product Service Plans
Product Performance Insurance Plans
Automatic Periodic Authenticated Product Ordering Agreement
Collateralization Services
Electronic Product Appraisal Services
External Product Appraisal Services
Product Valuation Certificates & Product Ownership Certificates Services
Broker Services
Direct Incentive Authentication Link Post Purchase Offer Availability

eSafeBay shopping may be conducted by non-members through their own aforementioned digital devices; however, the authenticated product won at auction or purchased may not be automatically transferred to the new purchaser via automatic: Electronic Ownership, Rebate Filing, Appraisal Record Transfer, issuance of Product Valuation Certificates & Product Ownership Certificates Services, etc. Subsequent utilization of eSafeBay System data for non-members may require the completion of data transfer documents and impose a fee to transfer or perform various services. For instance, non-members may be charged a fee to perform “Authentication Challenges”, distribute a product's appraisal data, etc.

The eSafeBay auction and shopping facilities and components are safe guarded by implementing the “validation, authenticity and certification” technologies contained within the aforementioned US patent applications: “Security authentication system for collectible and consumer items”, “Secure RFID authentication system” and “Secure RFID Authentication System using non-trusted communications agents”.

eSafeBay customers are assured that the products they bid on within an eSafeBay auction (FIG. 5) or purchase directly from an eSafeBay eCommerce site (such as a secure “Purchase Authentication System” site), are fully authenticated and verified against being counterfeited, pirated, stolen, damaged, recalled, swapped, unlawful, etc.

eSafeBay Worldwide Web Session and Cellular Telephone Connection Verification

### Prove-It Authenticity Technology

In addition to the typical secure website which incorporates the current security protocols, an eSafeBay website includes an (Trust Authority/Authentication Authority) auto-generated instance verification certificate and authenticity key that can be reviewed by the customer at anytime within the eSafeBay product auction or shopping session. By pressing a “Prove It” button, the user is presented with a verification certificate containing a verification key that incorporates the users previously supplied Personal Identification Number or significant code value that proves the validity of the auction or shopping session”. Its intent is to provide assurance that the session is secure, occurring in real-time, non-static, not-spoofed, not malicious, and trust worthy. Also, the product's availability and conformance to eSafeBay participation rules pertaining to: registered ownership, lawfulness, clear recall status, clear consumer warnings, and appropriate manufacturing details is provided to the user for inspection.

The issuance of both a real-time confirmation and digital certificate insuring that the products offered for auction or sale are successfully validated, have current and not static data in any capacity, and that the product is not compromised in any manner. On the website, there's a link to the trust authority agent's web service that performs a real-time re-authentication of the product's store public key and checks that the product's public key for: proper ownership, lawfulness, clear recall status, clear consumer warnings, proper manufacturing details, etc., and shows the result of such computation of the validation check.

The validation check contains a secure user supplied “trusted numeric key” embedded within the return user verification key that incorporates digits specifying where in the generated key the user's numeric “trusted numeric key” resides (as represented in the example below or another “trusted numeric key” algorithm):

### User Supplied—Trusted Numeric Key Code=336

### Example 1: 1093459938663788960 11/04/2007 11:18:07 AM 4254 Coach Bag

### Example 2: 2143499389485933605 11/04/2007 11:18:07 AM 4254 Coach Bag

The first digit specifies the direction of the key:
Odd=reversed
Even=forward
The next two digits specify the starting position of the numeric key:
Example 1: 1=reversed numeric key, starting at the 9th position, key=663
Example 2: 2=forward numeric key, starting at the 14th position, key=336

Upon verifying the appropriate position of the Trusted Numeric Key Code within the verification key, the eSafeBay user at this point, may elect to subject the product being auctioned or purchased be enrolled to receive one or several of the aforementioned Enhanced Services, such as: Electronic Ownership, Rebate Filing, Appraisal Record Transfer, issuance of Product Valuation Certificates & Product Ownership Certificates Services, etc.

### Call Back Authenticity Technology

An eSafeBay cellular telephone implementing “Call Back Authenticity Technology” (or another connection validation method) to connect the cellular telephone to the eSafeBay network utilizing a secure connection which incorporates current (or future) cellular authenticity and access security protocols, along with an auto-generated instance verification certificate and a validation key that can be reviewed by the user at anytime within the eSafeBay product auction or shopping session. By pressing a “Prove It” button, the user is presented with a verification certificate either in digital and/or audible context, containing a verification key (as above) that incorporates the user's previously supplied Personal Identification Number and/or the user's own biometric auditory key, consisting of a “verification phrase” previously spoken from the user's lips and recorded within the eSafeBay system.

Call Back Authenticity Technology insures the security and validity of the auction or shopping session. Its intent is to provide assurance that the session is secure, occurring in real-time, non-static, not-spoofed, not malicious, and trust worthy. Also, the product's availability and conformance to eSafeBay participation rules pertaining to: registered ownership, lawfulness, clear recall status, clear consumer warnings, and appropriate manufacturing details is provided to the user for inspection.

Optionally, the same level of product verification for: registered ownership, lawfulness, clear recall status, clear consumer warnings, manufacturing details, but the delivery mechanism employs a “return call” from the eSafeBay System that presents the user's own biological key, a “verification phrase” spoken from the user's lips and recorded within the eSafeBay system.

User Supplied—Trusted Spoken Phrase=“Help Mr. Wizard”

As an example, the user receives a return call from the eSafeBay System directly to the cellular telephone that is in use for the auction or shopping session, and upon responding with a “hello”, the eSafeBay system reiterates their personal “Trusted Spoken Phrase” thereby hearing from their cellular telephone's ear piece “Help Mr. Wizard”.

In addition, the user is audibly apprised of the product's status with regards to:

Ownership verification, lawfulness verified, clear recall status, clear consumer warnings and the appropriate manufacturing details.

At this point, by using their cellular telephone, the user may elect to subject the product being auctioned or purchased to receive one or several of the aforementioned Enhanced Services, such as: Electronic Ownership, Rebate Filing, Appraisal Record Transfer, issuance of Product Valuation Certificates & Product Ownership Certificates Services, etc.

### Product Notification

eSafeBay System Product Notification alerts a user when a specific product of interest has been placed into auction or offered for sale. All available corresponding product—authentication and validation, manufacturing, ownership, appraisal and valuation data is distributed to the interested eSafeBay user, by one or a combination of the following methods, including but not limited to: an email notification message, an eSafeBay System web site notification prompt, a cellular telephone notification call, US Mail Letter, or any other existing or future notification modality.

### Product Request

An eSafeBay System Product Request Service informs eSafeBay registered owners of specific products that another individual desires to purchase that product from them. In such situations, an eSafeBay System Notification message is sent to from the eSafeBay system to the registered owner of the specific product and an eSafeBay System Product Request confirmation is sent to the actual requester. All available corresponding product—authentication and validation, manufacturing, ownership, appraisal and valuation data is included within the Request confirmation distributed to the interested eSafeBay requestor, by one or many of the following methods, including but not limited to: an email notification message, an eSafeBay System web site notification prompt, a cellular telephone notification call, US Mail Letter, or any other existing or future notification modality.

### Reservation System

An eSafeBay System Product Reservation Service allows eSafeBay System members to automatically reserve products either placed into auction or offered for sale within the eSafeBay System. This reservation service ensures the eSafeBay System member inclusion within an auction provided a sufficient number of participation slots exist within the auction or for the ability to purchase a product that is offered for sale should there be a sufficient quantity available. In an auction, the association between a reservation and position within an auction corresponds to the eSafeBay System member's reservation number with the eSafeBay System member having reservation # 1 occupying the first auction participation position, and the eSafeBay System member having reservation # 2 occupying the second auction participation position, and so on.

In a sales offering, the association between a product and its purchaser ordering corresponds to the eSafeBay System member's reservation number for that product with the eSafeBay System member having reservation # 1 occupying the first purchase capability positioning, and the eSafeBay System member having reservation # 2 occupying the second purchase capability positioning, and so on.

Should the reservation # 1 holder fail to purchase the product within the allotted time period, the next eSafeBay customer on the “waiting list” is automatically informed via digital communication on their cellular telephone, email, home phone, fax, etc. that they are now eligible to purchase the product or reserve the desired product for a specific period of time.

All appropriate supporting data and documentation detailing the product and reservation position and auction or sales status is conveyed to the eSafeBay System member using the eSafeBay System Notification system.

In both the eSafeBay System auction and purchase segments, the aforementioned validation, authentication and security protocols are fully implemented and incorporated.

### Payment Services

eSafeBay System Payment Services orchestrate the exchange of funds in the appropriate currency between an auctioneer and auction winner or a seller and purchaser. The source of funds used to complete an eSafeBay System transaction may result from, but is not limited to: eSafeBay Account Debits, Bank Account Debits, Credit Card transactions, Affiliated Payment Cards, Checking Account withdrawal, Automated Teller Machine ATM card debit, Wire Transfer, Checking Account check submission, or Money Order submission.

Automatic exchange of electronically available funds may occur once an Auction Winner's or Purchaser's Delivery Product Reception confirmation is electronically received by the eSafeBay System.

### Financing Services

eSafeBay System Financing Services may provide both short and long term finance to/orchestrate the exchange of funds in the appropriate currency between an auctioneer and auction winner or a seller and purchaser. Such eSafeBay System Financing services facilitate the creation and execution of the appropriate Financial Loan instruments prior to the disposition and usage of funds to complete the auction or purchase obligations.

### Brokerage

eSafeBay System Brokerage Services facilitate the creation of auction or sales offering and inclusion of products within auctions and sales campaigns.

1. A system to securely authenticate an item or product offered for auctioning or sale, comprising:
an electronic circuit associated with the item wherein the electronic circuit includes an electronically readable identifier and embedded cryptographic data and a cryptographic calculator to encrypt a response to a challenge received by the electronic circuit using the embedded cryptographic data, the embedded cryptographic data being an encryption key and other cryptographic data related to the electronic circuit;
an authenticating entity that stores the electronic readable identifier and the encryption keys associated with the embedded cryptographic data;
a reader configured to bi-directionally communicate wirelessly with the electronic circuit;
a network connection connecting the reader to the authentication entity wherein the reader is configured to communicate at least the electronically readable identifier and the encrypted response;
a validation module to execute a validation process configured to be initiated by the authentication entity or the reader, the validation process computes an expected response using the electronically readable identifier, stored encryption keys and the stored embedded cryptographic data to validate the encrypted response by comparing the expected response to the encrypted response; and
wherein the authentication entity is configured to provide an authenticity indicator to indicate a result of the validation process

2. The system of claim 1, wherein said authenticity is established within a secure authenticated auction/or eCommerce shopping environment for acquiring products and services

3. The system of claim 2, wherein said authenticity is conducted by an authenticated digital device such as a cellular telephone, or an RFID Reader, PDA, PC, Laptop, electronic Notebook, Scanner, or any other form of electronic Trusted RFID reading device that can be accessible, communicated with, authenticated and capable of reading or interacting with any form of RFID Tag, Bar Code, Hash, Encrypted Serial Number, Electronic Product Code, Product Markup Language, and/or future product identification process

4. The system of claim 2, wherein said products can be converted from eSafeBay non-compliant (non-authenticatable) status to compliant (authenticatable) status be undergoing an eSafeBay Appraisal Service analysis wherein an eSafeBay authorized appraiser determines the non-compliant product's authenticity against being counterfeited, pirated, stolen, damaged, recalled, swapped, unlawfulness, etc., and upon “passing” such an authenticity evaluation, an eSafeBay compliant RFID tag is permanently attached to/or embedded within said product

5. The system of claim 4, wherein the eSafeBay Appraisal Service analysis outcome and supporting information is stored and accessible from within the eSafeBay computer system's database(s)

6. The system of claim 3, wherein Restrictive Access is established that electronically prevents NON-eSafeBay authorized RFID Readers “or rogue readers” from accessing an eSafeBay compliant product's RFID data and associated data, and/or from electronically accessing or interacting with the eSafeBay system

7. The system of claim 2, wherein products won at auction or purchased within the eSafeBay system are subsequently authenticated at the time of their physical receiving whereby the Pass/Valid or Fail/Invalid challenge results are conveyed to the customer's RFID interrogator/reader equipped Cellular Telephone as identified within claim 3

8. The system of claim 2, whereby the eSafeBay system offers customers “Enhanced Additional Services” such as: Electronic Ownership Registration, Electronic Completion and Electronic Filing of Rebates, Product Delivery Scheduling, Product Service Plans, Product Performance Insurance Plans, Automatic Periodic Authenticated Product Ordering Agreement, Collateralization Services, Electronic Product Appraisal Services, External Product Appraisal Services, Product Valuation Certificates & Product Ownership Certificates Services, Broker Services, Direct Incentive Authentication Link Post Purchase Offer Availability for either compliant or non-compliant products

9. The system of claim 1, whereby the provision of extended real-time session validation and transaction authentication is conveyed to customers, such as:
the application of “Prove-It Authenticity Technology” that provides assurances that the auction or shopping session is secure, current occurring in real-time, non-static, not-spoofed, not malicious, and is indeed trust worthy.
the application of “Call Back Authenticity Technology” that insures the legitimate participation of an eSafeBay customer's cellular telephone (or personal computers, PDA, etc.) within an auction or shopping session by requiring the eSafeBay customer to provide their Personal Identification Number and/or their own biometric auditory key as a “validation phrase” necessary for continued participation or transaction completion.
the application of “Trusted Spoken Phrase” validation repeats a secure phrase meaningful to the eSafeBay customer that audibly reiterates and confirms the product's status regarding: Ownership verification, lawfulness, recall status, consumer warnings, manufacturing details, etc.

10. The system of claim 2, wherein “Product Notification Services” provide an eSafeBay customer a notification message when a desired product is placed into auction or offered for sale

11. The system of claim 2, wherein “Product Request Services” inform other eSafeBay registered owners of specific products that another individual desires to bid-upon in auction or to purchase that product from them

12. The system of claim 2, “Product Reservation Services” allow an eSafeBay member to automatically reserve products either placed into auction or offered for sale within the eSafeBay System. For an auction reservation, an eSafeBay member is automatically provided inclusion within an auction for specific products. In a sales offering, the eSafeBay customer at the # 1 reservation position is given the first opportunity to purchase a desired product. Other eSafeBay customers desiring an opportunity to purchase the product are placed on a “waiting list”

13. The system of claim 7, wherein “Automatic Payment and Secure Exchange” of electronic funds occur once an Auction Winner or Purchaser receives their product where a Product Delivery authentication challenge being successful and a real-time delivery confirmation is electronically transmitted to and received by the eSafeBay System

14. The system of claim 13, whereby the services of claim 8 are offered to the eSafeBay customer upon reception of the eSafeBay acquired product
